(19) United States
(12) Patent Application Publication
(10) Pub. No.: US 2008/0148392 A1
(43) Pub. Date: Jun. 19, 2008

(54) METHOD AND APPARATUS FOR STORING, RETRIEVING AND VIEWING PERSONAL PASSCODES

(75) Inventors: Jody H. Akens, Weston, FL (US); George Mtchedlishvili, Hallendale, FL (US); Robert J. Sanchez, Cooper City, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/610,209

(22) Filed: Dec. 13, 2006

(51) Int. Cl. H04L 9/32

(52) U.S. Cl. 726/19

(57) ABSTRACT

An apparatus and method provide a user with the ability to store, retrieve and view numerous passcodes in a simple yet secure fashion. Components (300) including a memory (314), a display (112/312), a keypad (108/308), a universal serial bus (USB) port (104/304) and a fingerprint scanning module (106/206/306) are incorporated into a portable housing (102/200/400) or integrated within a cell phone (200) or two-way radio design. A user's passcodes are downloaded via the USB and stored for later retrieval. Upon validation of the user's fingerprint and personal identifier, an individual's passcodes are displayed.

### FIELD OF THE INVENTION

The present invention relates generally communication devices and more particularly to the storing, retrieving and viewing of personal passcodes used in communication devices.

### BACKGROUND

Today, an individual is likely to use a variety of personal passcodes to access a wide variety of secure devices. Passcodes, in the form of individual passwords, personal identification numbers (pins), log-in information, core-identification, access phrases and the like are typically required for the individual to operate a computer, access email, retrieve bank records, open a safe, etc. These passcodes can vary in length and must often meet strict security guidelines, such as a lengthy multiple digits having a minimum number of letters, numbers and symbols. At any given time, an individual may have multiple passcodes covering one or more systems. The security integrated within many systems often requires that the passcodes not be formed of easily recognized words or phrases. Many systems and databases also require users to change passcodes on a regular basis. While updating passcodes does help protect the security of the user's information, many people find managing multiple passcodes and the constant updating of the passcodes to be problematic. Long strings of numbers along with complex lettering and symbol combinations are difficult for a user to remember. Unfortunately, some people may resort to writing and carrying passcodes on a piece of paper within wallets or purses, taping lists of passcodes under desks or even onto the device itself.

Accordingly, it would be desirable have a means to store, retrieve and view personal passcodes, in a secure and easily transportable fashion.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a portable passcode storage device in accordance with some embodiments of the invention;

FIG. 2 is a portable passcode storage device in accordance with a cell phone embodiment of the invention;

FIG. 3 is an electrical block diagram of the portable secure passcode storage device in accordance with some embodiments of the invention;

FIG. 4 is a top view of a passcode storage device in accordance with some embodiments of the invention;

FIG. 5 is a bottom view the storage device of FIG. 4 in accordance with some embodiments of the invention; and

FIG. 6 is a flowchart providing a method for accessing passcodes in accordance some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in an apparatus and method for storing and accessing a user's personal passcodes. For the purposes of this application, the term passcode shall refer to passwords, personal identification number (pin), log-in and core IDs and/or any combination of letters, numbers or symbols used by an individual for accessing a secure device, system, database, and the like. Accordingly, the apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

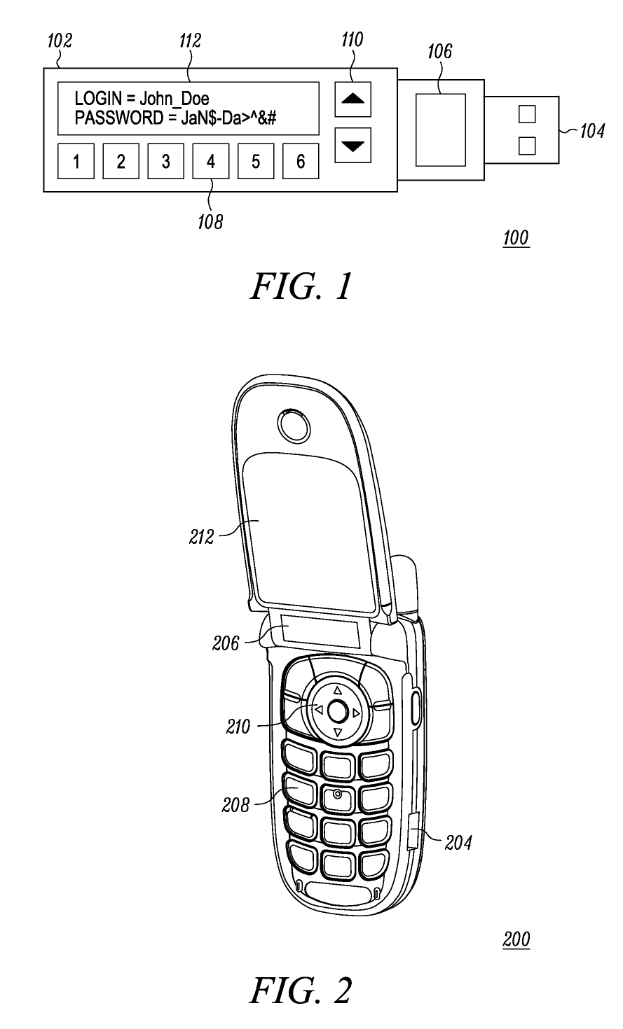

FIG. 1 is a portable passcode storage device in accordance with some embodiments of the invention. Portable passcode storage device 100 allows a user to easily store, retrieve and view personal passcodes. Portable device 100 includes portable housing 102 having electronic circuitry, shown in FIG. 2, including a memory stored therein. A universal serial interface (USB) port 104 is coupled to the housing 102 for transferring passcodes from a remote computer (not shown) into the memory. A fingerprint reader 106, such as a swipe style reader, is provided for reading a user's fingerprint. A keypad 110 allows a user to enter a personal identifier. A display 112 displays the stored passcodes to the user in response to the fingerprint and personal identifier being validated. Scroll key(s) 110 are preferably included as part of the keypad to allow a user to scroll through the plurality of stored passcodes, thus allowing the device 100 to use small housing and small display making the overall device readily portable or even integratable into portable electronic devices such as cell phones and two-way radios.

FIG. 2 is a portable secure passcode storage device in accordance with a cellular telephone embodiment of the invention. Cell phone 200 includes a fingerprint reader 206 and USB port 204 integrated thereon. The USB 204 allows for connection to a personal computer and the download of passcodes into the cell phone's memory, for later retrieval by the user, via the cell phone's keypad 208. In this embodiment, the cell phones existing keypad 208 may be used to enter and store the user's personal identifier. The cell phone's the existing scroll keys 210 may also be used to scroll through the plurality of passcodes stored therein by the user. Incorporating the finger print reader 206 and USB port 204 into the design of cell phone 200 allows the user to carry his or her passcodes securely without the need to carry an additional device.

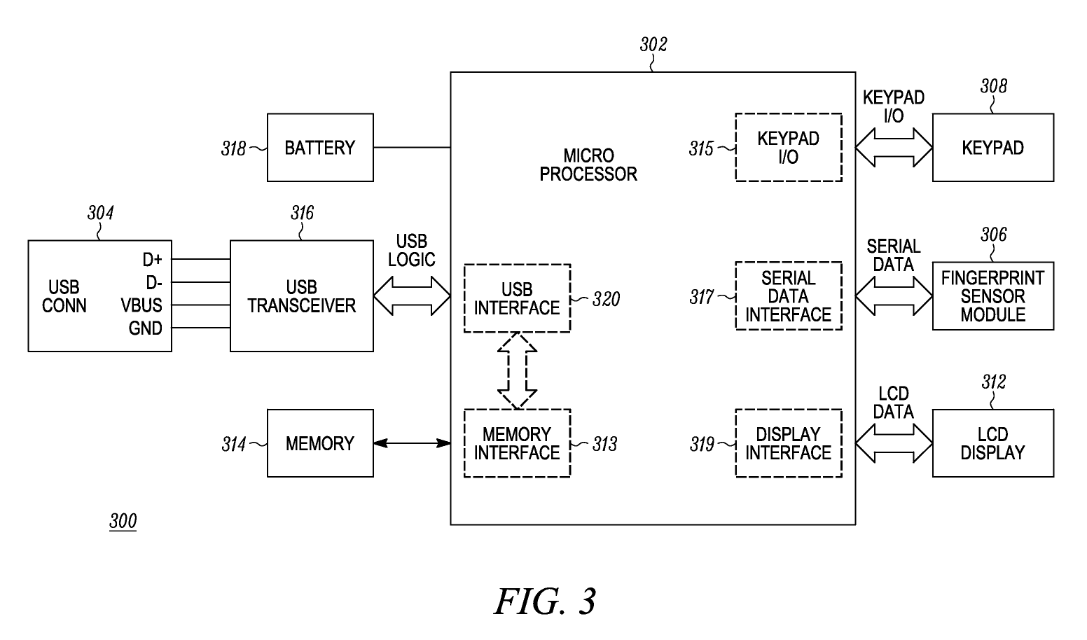

FIG. 3 is an electrical block diagram of the portable secure passcode storage device in accordance with some embodiments of the invention. The electrical block diagram shows only those components used for the storage, retrieval and viewing of a user's personal passcode whether stored within an independent device or cell phone. Components, such as the cell phone's audio and RF circuitry, are not shown. Block diagram 300 includes a controller, such as microprocessor 302, interfaced with fingerprint sensor module 306, keypad 308, display 312, external memory 314, USB transceiver 316 and battery power 318. Microprocessor 302 includes memory interface 313, keypad interface 315, serial data interface 317, display interface 319 and USB interface 320. The USB connector 304 (corresponding to USB connector 104 or 204 of FIG. 1 or 2) is coupled to the USB transceiver 316 for the transfer of passcode information via the microprocessor's USB interface 320. Microprocessor memory interface 313 transfers the passcode information to external memory 314 for secure storage.

Upon initialization, a user enters and stores a personal identifier via keypad 308 and also scans fingerprint information via module 306, typically by swiping the index finger. Passcodes can then be automatically downloaded from an external computer via the USB 304 for storage into memory 314. The portable device is removed from the computer and carried by the user. The user can then later retrieve the stored passcodes by entering his or her personal identifier via the keypad 308 and swiping a finger, over fingerprint sensor module 306. The fingerprint sensor module 306 transfers the sensed fingerprint data to the microprocessor 302 for validation. The controller validates the user's personal identifier and fingerprint information to allow access to the stored passcodes. The stored passcodes are displayed on display 312 and the scroll keys of keypad 308 are used to scroll through and view the passcodes.

The utilizing of a USB connector and interface allows for complete a download of numerous passcodes. The use of a personal identifier provides additional security to that of the fingerprint swipe, but is also easy for the user to remember. The personal identifier is not restricted to the security requirements of typical passwords. The personal identifier could be a user's name, computer core ID or phone number, for example.

More than one person can use the portable passcode storage device of the present invention. The personal identifier simply identifies the user and the fingerprint swipe provides the secure access to that individual's passcode information. Thus, two people sharing a cell phone, for example, can store their passcode information on the same cell phone if desired. The execution code for the microprocessor 302 stores the passcodes under each individual's identifier, and permits access to the passcodes based on the fingerprint swipe aligning with the individual's identifier.

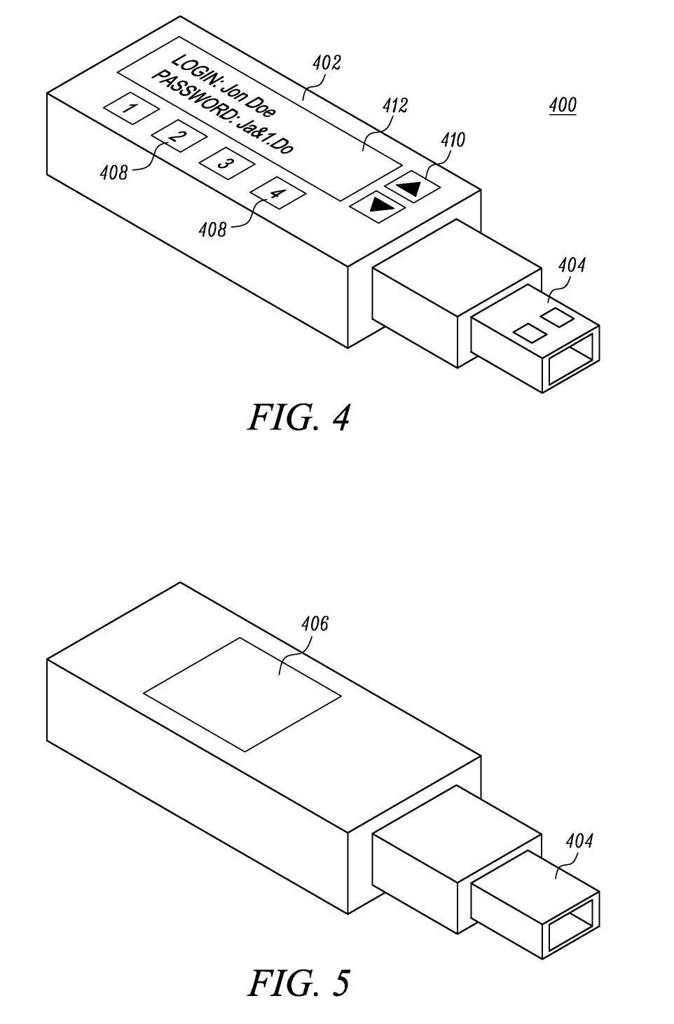

FIG. 4 is an example of a top view of a storage device in accordance with some embodiments of the invention. In this embodiment, a stand-alone device 400 is shown (as opposed to being integrated within a cell phone). Portable housing 102 includes USB connector 404, keypad 408, shown here as four numerical keys, scroll keys 410 and a small display 412. FIG. 5 is a bottom view of the storage device of FIG. 4 showing a fingerprint scanning portion 406. FIGS. 4 and 5 are shown to illustrate that the independent housing embodiment can take on a variety of form factors. While shown with four keys and scroll button, the keypad is used simply for entering a user's personal identifier and could have fewer keys or additional keys. The keypad 408 is not intended for entry of the passcodes but simply as a means for accessing the passcodes previously stored by the user into the device via the USB 404. The use of fewer keys, whether numerical or letters or a combination of both, allows a user to select a very simple easy to remember personal identifier. Thus, the personal identifier is user-selectable without the restriction parameters typically seen for the passcodes. In fact, even if a user were to write down their personal identifier on the portable device itself, there would be little danger of others accessing the user's passcode information due to the fingerprint scanning protection. The use of the personal identifier is particularly beneficial when more than one user wishes to store passcode information on a single device.

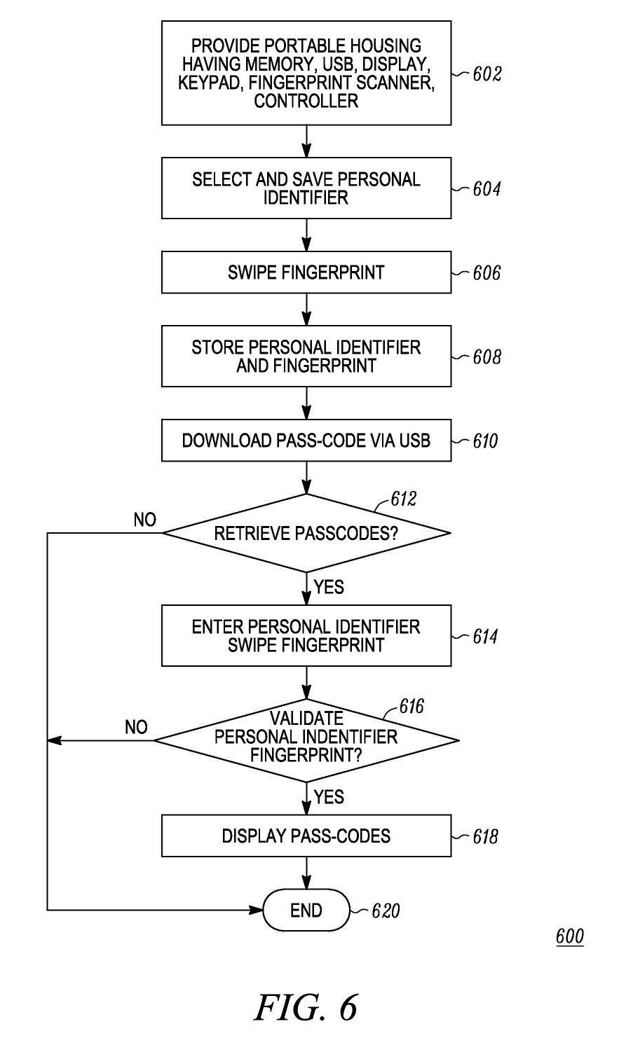

FIG. 6 is a flowchart providing a method 600 for storing and retrieving passcodes in accordance some embodiments of the invention. A portable housing having a memory, universal serial bus (USB) port, fingerprint scanner, display and keypad along with electronic circuitry for the control thereof are provided at 602. The method begins by having the user select, enter and save an easy to remember personal identifier via the keypad at step 604. As stated earlier, this personal identifier need not comply with any particular parameter restrictions. The user also swipes a designated finger over the fingerprint scanner at step 606. The scanned fingerprint information is stored at step 608, identifying the user's personal identifier with the stored fingerprint. The order of steps 604 and 606 can be reversed.

Following the entry of the fingerprint and personal identifier information, a plurality of the user's access-codes are downloaded at step 610 from a personal computer via the USB. When the user wishes to retrieve the passcodes at step 612, the user enters his/her personal identifier and swipes his/her fingerprint. Upon validation of the personal identifier and fingerprint at step 616, the passcodes are displayed to the user at step 618 ending the method at step 620.

Accordingly, there has been provided a method and apparatus for storing, retrieving and viewing a plurality of passcodes for one or more individuals in a simple yet secure fashion. By utilizing a user-selectable personal identifier in conjunction with fingerprint scanning and a USB port, individuals can now securely download, store and retrieve numerous passcodes. The retrieval is simple and quick. The user need only swipe their fingerprint and provide their unique personal identifier. Upon validation of the fingerprint and personal identifier, the user's individual passcodes are displayed. The components including memory, display, keypad, fingerprint scanner and USB can be formed into readily portable housing or integrated within a cell phone or two-way radio design.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. An apparatus for storing, managing and retrieving passcodes, comprising:
a portable housing having electronic circuitry including a memory stored therein;
a universal serial interface (USB) port coupled to the housing for transferring a plurality of passcodes from a remote computer into the memory;
a fingerprint reader for reading a user's fingerprint;
a keypad for entering a personal identifier;
a display for displaying the plurality of passcodes to a user in response to the fingerprint and personal identifier being validated by the electronic circuitry.

2. The apparatus of claim 1, wherein the personal identifier is user-selectable without restriction parameters.

3. The apparatus of claim 1, wherein the apparatus is accessible by a plurality of users, each user having a unique personal identifier and fingerprint information stored within the memory.

4. The apparatus of claim 1, wherein the keypad further includes a scroll key for scrolling through the plurality of stored passcodes.

5. The apparatus of claim 1, wherein the apparatus is incorporated as part of a cell phone.

6. A method for retrieving a passcode, comprising the steps of:
providing a portable housing having a memory, universal serial bus (USB) port, fingerprint scanner, display and keypad along with a controller for the operation thereof;
downloading passcodes into the memory within the portable housing via the USB;
scanning a fingerprint of a user via the fingerprint scanner;
entering a personal identifier by the user via the keypad;
validating the fingerprint and personal identifier via the controller; and
displaying the passcodes to the user on the display once the fingerprint and personal identifier are validated.

7. The method of claim 6, further comprising prior to the step of downloading:
selecting the personal identifier by the user without parameter restrictions;
saving the personal identifier; and
storing the user's fingerprint.

8. The method of claim 6 further comprising scrolling through the passcodes.

9. The method of claim 6 wherein the portable housing comprises the housing of a cellular telephone or two-way radio.

10. A portable radio, comprising:
a controller;
a memory;
a display;
a keypad for entering a user's personal identifier;
a fingerprint reader for scanning the user's fingerprint;
a universal serial bus (USB) port for downloading passcodes from a computer into the portable radio's memory; and
the portable radio displaying the passcodes on the display upon validation by the controller of the user's fingerprint and personal identifier.

11. The portable radio of claim 10, wherein the portable radio is a cellular phone.

12. The portable radio of claim 10, wherein the portable radio is a two-way radio.

13. The portable radio of claim 10, wherein the portable radio stores personal identifiers and fingerprint information for a plurality of users along with passcodes associated with and retrievable by each user.
